(19) United States
(12) Patent Application Publication
(10) Pub. No.: US 2016/0198722 A1
(43) Pub. Date: Jul. 14, 2016

(54) Aerosol Wildlife Scent Attractant and Distance Marker

(71) Applicants: Gregory S. Fisher, Carp (CA); Robert E. Brooks, III, Flanklin, TN (US)

(72) Inventors: Gregory S. Fisher, Carp (CA); Robert E. Brooks, III, Flanklin, TN (US)

(21) Appl. No.: 14/993,405

(22) Filed: Jan. 12, 2016

Related U.S. Application Data
(60) Provisional application No. 62/102,666, filed on Jan. 13, 2015.

(51) Int. Cl. A01N 61/00; A01M 7/00

(52) U.S. Cl. CPC A01N 61/00; A01M 7/0046

(57) ABSTRACT

An attractant and distance marking device for indicating predetermined distances from a hunting position, includes a solution having a dispersing agent and a suspension suspended in the dispersing agent. The suspension includes base paint, animal attractant, and pigment. A pressurized aerosol container has a body portion defining a sealed interior space and has an actuator, the interior space housing the solution, the actuator being configured to selectively disperse the solution from the interior space. The solution further includes an effective amount of thickening agent sufficient such that the solution has a consistency capable of adhering to environmental structure when dispersed from the interior space.

### REFERENCE TO RELATED APPLICATIONS

This application claims the benefit of provisional patent application U.S. Ser. No. 62/102,666 filed Jan. 13, 2015 titled Wildlife Scent Attractant and Distance Marker and which is incorporated herein by reference.

### BACKGROUND OF THE INVENTION

This invention relates generally to animal attractants that lure animals to a hunter and, more particularly, to a scent attractant that includes a colorized distance marking composition dispensed from an aerosol canister.

When hunting wild game, individuals are faced with the problem of trying to get the targeted animal within sufficient range to successfully harvest the animal, such as by shooting a crossbow or high powered rifle. Time spent waiting for the chosen animal to come within range is minimized if artificial attractants are used to lure the animal to come closer. Hunters are also faced with the problem of sufficiently judging the distance to the animal. Obviously, the shot will miss its target if the distance is judged improperly and if the shot is not adjusted accordingly.

Scent is frequently used in the process of hunting for animals. For example, it is common to spread male or female deer urine in a hunting zone to attract deer to be harvested. Specifically, the role of deer urine is to attract deer to pass within a reasonable distance of where the hunter intends to be personally located in his effort to harvest the deer, e.g. to take a shot. Urine or other scent may be introduced into an outdoor environment in several ways, such as hanging scent canisters from tree limbs, spraying scent from a bottle, and dropping a path of scent pellets.

Inducing an animal into a “kill zone” is one factor in experiencing a successful harvest of an animal. Another equally challenging factor, of course, is accurately shooting the animal, whether by crossbow or rifle. This involves the hunter accurately determining the distance to the animal and then making necessary adjustments for the angle of elevation, windage, and other parameters in order that an attempted shot is fatal. The distance between the hunter and the hunted animal is sometimes determined using an electronic range finder device or by positioning artificial distance markers in various directions radial to the hunter's position. Although presumably effective for their intended purposes, range finders are expensive and breakable while artificial marking devices must be packed, stored, and transported before use and picked up after use.

Therefore, it would be desirable to have an animal attractant in an aerosol canister that disperses a scent having a thick viscosity and a colorant (such as a dye) that can be sprayed onto environmental structures in a kill zone. Further, it would be desirable to have an animal attractant that is indicative of distance measurements when sprayed on environment structures remote from a hunter.

### SUMMARY OF THE INVENTION

An attractant and distance marking device for indicating predetermined distances from a hunting position, includes a solution having a dispersing agent and a suspension suspended in the dispersing agent. The suspension includes base paint, animal attractant, and pigment. A pressurized aerosol container has a body portion defining a sealed interior space and has an actuator, the interior space housing the solution, the actuator being configured to selectively disperse the solution from the interior space. The solution further includes an effective amount of thickening agent sufficient such that the solution has a consistency capable of adhering to environmental structure when dispersed from the interior space.

The invention functions as though it were a colored thick spray paint infused with animal attracting scent. The hunter can use this invention to mark anything they desire (i.e. tree, dirt, shrubs corn stalks) with a colored marking. Most commonly, this will be the distance to an object as marked and sprayed with a number for an accurate judgment of distance. Sequentially, a hunter would enter a hunting location and determine a specific location where they want to attract their game via the scent. They will then measure the distance from their hunting location to that spot and spray the attractant at that location to mark it for future reference (1E, the number 20 on a tree to mark a 20 yard distance). When the wild game approaches, the hunter then has a reference point and does not have to guess the distance, potentially resulting in a missed shot, or use a judging device that requires time and movement.

Therefore, a general object of this invention is to provide a wildlife attractant and distance marking composition for attracting an animal into proximity to a hunter intending to harvest the animal.

Another object of this invention is to provide a wildlife attractant and distance marking composition, as aforesaid, that includes a color composition capable of adhering to environmental structure and being indicative of a distance from a predetermined hunter's location.

Still another object of this invention is to provide a wildlife attractant and distance marking composition, as aforesaid, that includes a relatively thick viscosity that is capable of being dispersed from an aerosol canister, such as onto environmental structures.

Yet another object of this invention is to provide a wildlife attractant and distance marking composition, as aforesaid,

A further object of this invention is to provide a wildlife attractant and distance marking composition, as aforesaid, in which the markings on environmental structures may be indicative of distance measurements so as to aid a hunter in sighting his weapon.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a contextual perspective view of the environment of use for the present invention, namely, illustrating a hunter determining a location for application of the aerosol attractant and marking composition.

FIG. 2 is another contextual perspective view of the present invention, illustrating a hunter applying the attractant and marking composition to an environmental structure.

FIG. 3 is another contextual perspective view of the present invention, illustrating a hunter taking harvesting wildlife attracted into a kill zone created by use of the attractant and marking composition.

FIG. 4 is a perspective view of an aerosol container holding and dispensing the attractant and marking composition.

FIG. 5 is an isolated view on an enlarged scale of the attractant and marking composition applied to an environmental structure, e.g. a tree.

### DESCRIPTION OF THE PREFERRED EMBODIMENT

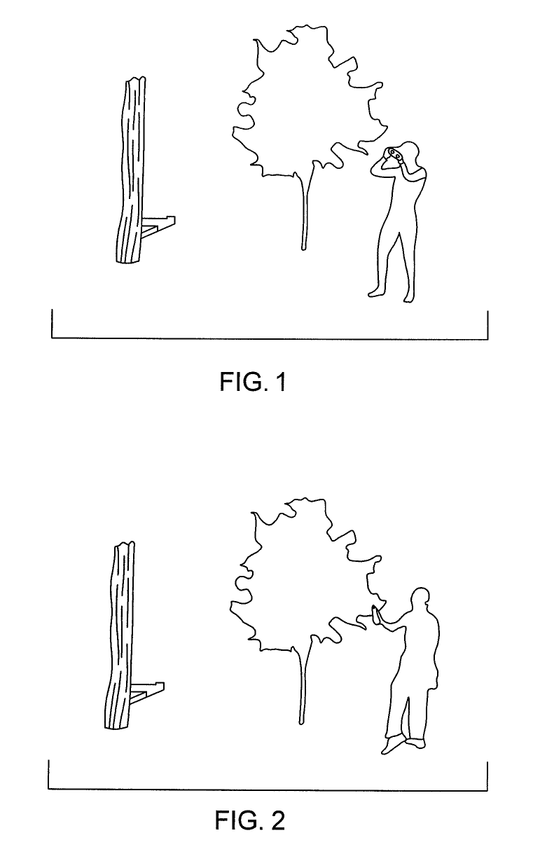

A wildlife attractant and distance marking composition according to the present invention will now be described in detail with reference to FIGS. 1 to 5 of the accompanying drawings.

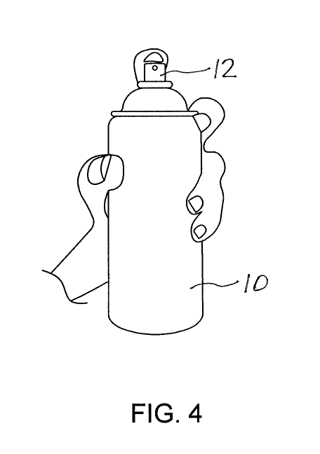

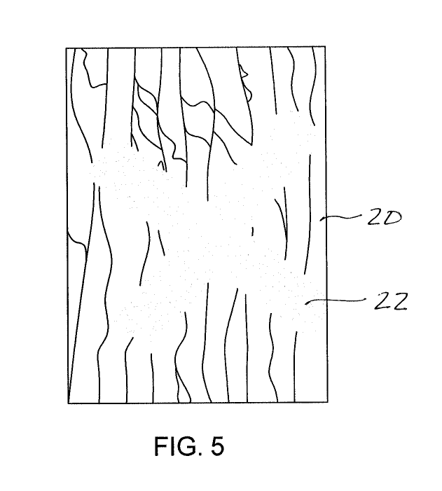

In one embodiment of the invention, an attractant and distance marking composition may be provided to allow a hunter to mark predetermined distances from a particular known hunting position (e.g., the hunter's blind or stand). The composition may be packaged in a pressurized aerosol container 10 having a body portion which defines a sealed interior space (FIG. 4). An actuator 12 may be configured such that, when activated, the aerosol container disperses the contents onto desired environmental structure 20.

The composition may be a suspension (e.g., a colloid) that includes a base paint, an animal attractant, and pigment. It may be desirous for the base paint to be opaque so that the hunter may be able to see the paint from a distance. The base paint may include water, a binder, a diluent or solvent, pigment or dyes, and additives to modify the effect of the product.

The binder may include synthetic or natural resins including but not limited to alkyds, acrylics, vinyl-acrylics, vinyl acetate, vinyl ethylene, polyeurethanes, polyesters, melamine resins, epoxy, and oils. Exemplary binders include cyclopentasiloxane, dimethicone, PEG/PPG-18/18 Dimethicone, Hydrogen Dimethicone, and Laurel PEG-10 Tris (Trimethylsiloxy) Silylethyl Dimethicone.

Solvents may be included in the composition to reach a desired viscosity. Acceptable diluents include water, glycerin, butylene glycol, for example.

The base color of the paint may be modified using pigments or dyes. Natural or synthetic pigments may be acceptable, including clays, calcium carbonate, mica, various silicas, talks, calcined clays, alkyd resins, metal-based pigments, inorganic pigments, biological pigments, organic pigments, precipitated calcium carbonate, and synthetic pyrogenic silicas. Zinc oxide and/or sodium chloride, for example, may provide a white color to the paint. Dyes may also be used to modify the base color. For example, food coloring may be acceptable for creating the desired color.

The solution may further include a thickening agent so that the solution has a consistency capable of adhering to environmental structure 20 when dispersed from its container. Glyceryl caprylate, for example, is a natural thickening agent, and may be used to thicken the solution of the present invention.

Various dispersants may additionally be included to aid in the suspension of the various particles in the composition. Exemplary dispersants include caprylyl methicone, cetyl PEG/PPG-10/1 dimethicone, and glyceryl undecylenate.

Polymethylsilsequioxane is a silicone ingredient that increases a product's ability to repel water. Including polymethylsilsequioxane in the composition may prevent the product from diluting in inclement weather, such as rain or snow.

Due to the desirability of applying the paint to environmental structure, it shall be recognized by those in the art that it may be preferable for the base paint to be composed of biodegradable substances. Further, the base paint may be a natural paint, such as clay paint, for example, which may be naturally biodegradable.

An animal attractant may further be added to the paint to attract wildlife to the desired location. The animal attractant may be a perfume (e.g., stearlkonium hectorite), a natural scent, such as animal urine or glandular secretions, or a chemical composition that replicates an animal's scent or other desirous scent (such as an animal's preferred food). To achieve the desired scent of the overall product, it shall be understood by those in the art that the product absent the animal attractant may preferably be odorless so as not to deter an animal from scents not familiar to the animal. Because animals are often attracted by scents that are repugnant to humans, it may additionally be desirable for the overall product, including the attractant, to have no discernable scent to a human. In addition, the attractant may be in the form of a “cover scent,” meaning that the scent specifically covers a human's scent so it is not detected by a deer, or perhaps to distract a deer from the smell of a human, making the hunter more effective.

A propellant may be included in the aerosol container 10 for the purpose of moving the solution from the container to the desired environmental structure 20. The propellant may be a hydrocarbon, a fluorocarbon, or both. Squalane is one example of a hydrocarbon, although there are many known fluorocarbons and hydrocarbons that may be acceptable.

The propellant may be from about 20% to about 60% of the total product in the aerosol container. More particularly, the propellant may be from about 25% to about 55% of the total product, and most particularly from about 28% to about 54% of the total product in the aerosol container 10.

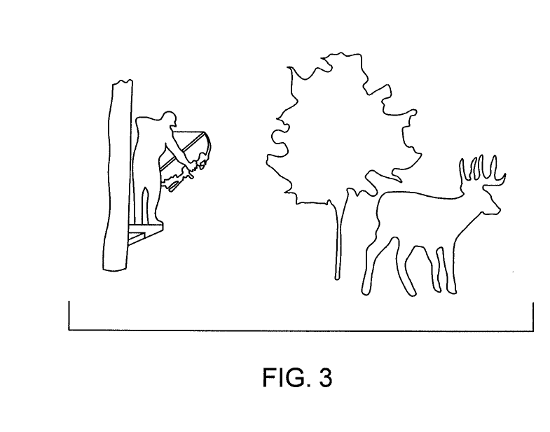

The propellant may allow the product to be sprayed onto desirable environmental structure 20. As illustrated by the figures, a hunter may scout an area to determine a location for a “kill zone,” (FIG. 1) and then spray the composition onto a tree, such as on the bark or foliage, such that it is visible to the hunter from a predetermined distance (FIG. 2). Specifically, the hunter may spray an “X” 22 (FIG. 5) on a tree to indicate one distance and spray another shape indicia on another landmark (not shown) to indicate another distance. Alternately, it may be desirable to spray the composition directly onto the ground, such as on grass, dirt, or other ground covering (including but not limited to corn stalks, soybeans, milo, etc.). FIG. 3 illustrates a hunter preparing to harvest an animal now present in the kill zone. Non-aerosol spray bottles with a trigger are also contemplated as an alternative containment and delivery means to aerosol containers.

It is understood that while certain forms of this invention have been illustrated and described, it is not limited thereto except insofar as such limitations are included in the following claims and allowable functional equivalents thereof.

1. An attractant and distance marking device for indicating predetermined distances from a hunting position, comprising:
a solution comprising a dispersing agent and a suspension suspended in said dispersing agent; said suspension comprising base paint, animal attractant, and pigment;
a pressurized aerosol container having a body portion defining a sealed interior space and having an actuator, said interior space housing said solution, said actuator being configured to selectively disperse said solution from said interior space;
wherein said solution further includes an effective amount of thickening agent sufficient such that said solution has a consistency capable of adhering to environmental structure when dispersed from said interior space.

2. The attractant and distance marking device as in claim 1, wherein said animal attractant is selected from the list consisting of: pure animal urine, animal gland secretions, and synthetic perfumes.

3. The attractant and distance marking device as in claim 2, wherein said animal attractant is deer urine from a male or female deer.

4. The attractant and distance marking device as in claim 1, wherein said animal attractant has no scent discernible to humans.

5. The attractant and distance marking device as in claim 1, wherein said environmental structure is selected from the group consisting of tree bark, grass, foliage, and a ground surface.

6. The attractant and distance marking device as in claim 1, further comprising a propellant, wherein said propellant is from about 25% to about 55% of the total product.

7. The attractant and distance marking device as in claim 1, further comprising a propellant, wherein said propellant is at least one of a fluorocarbon and a hydrocarbon.

8. The attractant and distance marking device as in claim 1, wherein said pigment is at least one item selected from the list consisting of: an alkyd resin, a metal-based pigment, an inorganic pigment, a biological pigment, an organic pigment, and food coloring.

9. The attractant and distance marking device as in claim 1, wherein said base paint is opaque.

10. The attractant and distance marking device as in claim 1, wherein said base paint is biodegradable.

11. A semi-viscous attractant and distance marking composition, comprising a mixture of:
an effective amount of binder;
an effective amount of solvent;
pigment;
an effective amount of additives such that said composition exhibits a consistency capable of adhering to environmental structure; and
a wildlife attractant.

12. The composition as in claim 11, further comprising propellant, and wherein said composition is packaged in an aerosol can, said propellant allowing said composition to be sprayed onto said environmental structure.

13. The composition as in claim 11, wherein said wildlife attractant is at least one item selected from the list consisting of: pure animal urine, animal gland secretions, and synthetic perfumes.

14. The composition as in claim 11, wherein said additives include a thickening agent.

15. The composition as in claim 11, wherein said composition is opaque.

16. The composition as in claim 11, wherein said pigment is at least one item selected from the list consisting of: an alkyd resin, a metal-based pigment, an inorganic pigment, a biological pigment, an organic pigment, and food coloring.

17. The composition as in claim 11, wherein said binder, solvent, pigment, additives, and attractant are biodegradable.

18. A semi-viscous wild-game attractant and marking composition, comprising:
an odorless, biodegradable, opaque base paint composition;
an odorless thickening agent;
a pigment; and
a wild game attractant.

19. The composition as in claim 18, wherein said wild game attractant is at least one item selected from the list consisting of: pure animal urine, animal gland secretions, and synthetic perfumes.

20. The composition as in claim 19, wherein said pigment is at least one item selected from the list consisting of: an alkyd resin, a metal-based pigment, an inorganic pigment, a biological pigment, an organic pigment, and food coloring.
